(19) United States
(12) Patent Application Publication
(10) Pub. No.: US 2025/0179804 A1
(43) Pub. Date: Jun. 5, 2025

(54) QUICKLY INSTALLED, EXPANDABLE, AND MODULARLY DESIGNED LOUVER AWNING

(71) Applicant: Zhejiang Yotrio Group Co., Ltd., Linhai (CN)

(72) Inventors: Licong CHEN, Linhai (CN); Jianqiang XIE, Linhai (CN)

(73) Assignee: Zhejiang Yotrio Group Co., Ltd., Linhai (CN)

(21) Appl. No.: 18/611,052

(22) Filed: Mar. 20, 2024

(30) Foreign Application Priority Data
Nov. 30, 2023 (CN) 202311635854.2

(51) Int. Cl. E04F 10/10

(52) U.S. Cl. CPC E04F 10/10

(57) ABSTRACT

A quickly installed, expandable, and modularly designed louver awning includes several leg tubes, a ring beam frame disposed on upper ends of the leg tubes, and a louver system disposed on the ring beam frame. The ring beam frame includes several ring beams slidably installed on the leg tubes, ring beam linings are firmly disposed in ends of the ring beams, and the ring beam linings are connected to the leg tubes through first fasteners. The ring beams and the leg tubes are connected through leg tube linings and the ring beam linings, so that structural strength of the ring beams and the leg tubes is increased, a part quantity is reduced, assembly is easier to operate with a smaller error, and the fasteners are not exposed, thereby providing better aesthetic appearance.

### CROSS-REFERENCE TO RELATED APPLICATIONS

This application claims priority to Chinse Patent Application No. 202311635854.2, filed Nov. 30, 2023, which is hereby incorporated by reference in its entirety.

### FIELD OF TECHNOLOGY

The present invention belongs to the field of outdoor leisure products, and in particular, relates to a quickly installed, expandable, and modularly designed louver awning.

### BACKGROUND

A louver awning is an awning used outdoors, with a folded and unfolded louver system at the top. The following problems usually exist in existing louver awnings.

(1) Existing leg tubes and ring beams are usually connected through corner fittings. In this connection manner, multiple accessories are needed, an assembly error and difficulty are large, and screws are exposed, which do not provide an aesthetic appearance.

(2) The existing louver awnings are single and independent structures, so that splicing or expansion of multiple louver awnings cannot be implemented.

(3) For an existing louver system, a rocking rod and a worm gear mechanism are usually used to control folding and unfolding. An input shaft of the worm gear mechanism is provided with a hanging ring, and an upper end of the rocking rod is provided with a hook. The hook hooks the hanging ring. When the rocking rod is turned, the rocking rod drives the worm gear mechanism to work. However, the hook on the rocking rod can only hook the hanging ring from a side surface, so that alignment is difficult to perform, and not easy to operate.

(4) The existing louver system is usually driven manually or electrically. In the electrical driving manner, a motor module is to be installed on a ring beam for driving, but the motor module is exposed above the ring beam, which does not provide an aesthetic appearance and results in a poor protection effect.

### SUMMARY

To overcome shortcomings in conventional technologies, the present invention provides a technical solution for a quickly installed, expandable, and modularly designed louver awning.

The quickly installed, expandable, and modularly designed louver awning includes several leg tubes, a ring beam frame disposed on upper ends of the leg tubes, and a louver system disposed on the ring beam frame. The ring beam frame includes several ring beams installed on the leg tubes, the ring beams are slidably installed on the leg tubes, ring beam linings are firmly disposed in ends of the ring beams, and the ring beam linings are connected to the leg tubes through first fasteners.

Further, the ring beam lining is connected to a ring beam baffle plate through the first fastener, the ring beam baffle plate is suspended and extends inside the leg tube through the first fastener. The ring beam lining and the ring beam baffle plate sandwich a shell wall of the leg tube. The first fastener is installed in the leg tube and the ring beam and connects the ring beam lining, the ring beam baffle plate, and the shell wall of the leg tube.

Further, a leg tube lining is fastened in the upper end of the leg tube, and the ring beam lining and the leg tube lining are connected through the first fastener.

Further, the leg tube lining includes a leg tube lining body and two leg tube lining connecting parts respectively disposed on two sides of the leg tube lining body, the leg tube lining body is configured to be embedded in a tube cavity of the leg tube, and the leg tube lining connecting parts are configured to be connected to the ring beam lining.

Further, the leg tube lining body is an L-shaped structure or a U-shaped structure.

Further, the leg tubes are capable of being connected to ring beams of the other one or more louver awnings, to implement splicing or expansion between different louver awnings.

Further, the louver system includes a louver apparatus disposed on an upper end of the ring beam frame, a worm gear mechanism configured to drive the louver apparatus to fold and unfold, and a rocking rod configured to drive the worm gear mechanism to work. An upper end of the rocking rod is provided with a limiting part, an input end of the worm gear mechanism cooperates with and is connected to a hanging piece, the hanging piece is provided with a limiting groove, a bottom opening, and a side opening. The limiting groove communicates with the bottom opening, and the limiting groove communicates with the side opening. The limiting groove is configured to limit and cooperate with the limiting part, the bottom opening is used for the limiting part to extend into the limiting groove from a bottom of the hanging piece, the side opening is used for the limiting part to extend from a side surface of the hanging piece into the limiting groove.

Further, the limiting groove and the side opening are horizontally penetrating structures, the bottom opening communicates with a lower end of the side opening and a front side of the limiting groove, the lower end and the front side penetrate to the outside, and an upper end penetrates to the side opening, and a rear side penetrates to the limiting groove.

Further, the limiting part includes two limiting pins respectively disposed on a left side and a right side of the rocking rod.

Further, the ring beam is provided with a ring beam slot, the louver system includes a louver apparatus disposed at an upper end of the ring beam frame and an electric driving module configured to drive the louver apparatus to fold and unfold. The electric driving module includes a cover plate and an electric driving mechanism disposed on the cover plate, the cover plate is detachably connected to the ring beam, and covers the ring beam slot, and the electric driving mechanism is installed in the ring beam through the ring beam slot.

Further, the electric driving mechanism includes a push rod and a push rod connecting piece rotatably connected to the push rod, and the push rod is an automatically telescopic push rod. A rear end of the push rod is connected to the cover plate through a third fastener, the cover plate is connected to a hoop member through a second fastener, and the hoop member holds a body of the push rod tightly on the cover plate.

Compared with the prior art, the present invention has the following beneficial effects.

(1) According to the present invention, the ring beams and the leg tubes are connected through the leg tube linings and the ring beam linings, so that structural strength of the ring beams and the leg tubes is increased, a part quantity is reduced, assembly is easier to operate with a smaller error, and the fasteners are not exposed, providing better aesthetic appearance.

(2) The louver awning in the present invention is designed as a modular structure, which may be spliced or expanded.

(3) According to the present invention, two angles including the bottom and the side surface are provided for the rocking rod to cooperate with the hanging piece, so that connection of the rocking rod is easier to align, more flexible, and easier to implement.

(4) According to the present invention, the cover plate is used as a carrier of the electric driving mechanism, and is configured to install the electric driving mechanism, and the electric driving mechanism is hidden inside the ring beam, to improve aesthetic appearance and protect the electric driving mechanism, and the cover plate can strengthen a structural strength of the ring beam. In addition, only the cover plate is to be disassembled and assembled, so that operation is easy to implement, and the electric driving module is easily and entirely replaced.

### BRIEF DESCRIPTION OF THE DRAWINGS

FIG. 1 is a schematic structural diagram of the present invention;

FIG. 2 is a schematic structural diagram of the present invention when a louver system is removed;

FIG. 3 is a schematic diagram of an installation process of a ring beam and a leg tube in the present invention;

FIG. 4 is a schematic structural diagram of connection of a leg tube and a leg tube lining in the present invention;

FIG. 5 is a schematic structural diagram of an exploded structure of a leg tube and a leg tube lining in the present invention;

FIG. 6 is a schematic structural diagram of connection of a ring beam, a ring beam lining, and a ring beam baffle plate in the present invention;

FIG. 7 is a schematic diagram of an exploded structure of a ring beam, a ring beam lining, and a ring beam baffle plate in the present invention;

FIG. 8 is a first schematic structural diagram of the present invention when expanded, in which a louver system is not shown;

FIG. 9 is a second schematic structural diagram of the present invention when expanded, in which a louver system is not shown;

FIG. 10 is a schematic structural diagram of installation of a hanging piece and a rocking rod of the present invention;

FIG. 11 is a first schematic structural diagram of an installation process of a hanging piece and a rocking rod of the present invention, in which a limiting part enters a limiting groove from an opening on a side surface;

FIG. 12 is a second schematic structural diagram of an installation process of a hanging piece and a rocking rod of the present invention, in which a limiting part enters a limiting groove from an opening at the bottom;

FIG. 13 is a schematic diagram of an exploded structure of an electric driving module of the present invention;

FIG. 14 is a schematic structural diagram of an electric driving module of the present invention;

FIG. 15 is a schematic structural diagram of a use state when an electric driving module of the present invention is installed on an inner side of a ring beam; and

FIG. 16 is a schematic structural diagram of a use state when an electric driving module of the present invention is installed on an outer side of a ring beam.

In the figures, leg tube 100, ring beam 200, ring beam slot 201, louver system 300, worm gear mechanism 301, rocking rod 302, limiting part 3020, hanging piece 303, limiting groove 3030, bottom opening 3031, side opening 3032, guide surface 3033, electric driving module 304, cover plate 3040, push rod 3041, push rod connecting piece 3042, second fastener 3043, hoop member 3044, third fastener 3045, movable opening 3046, ring beam lining 400, leg tube lining 500, leg tube lining body 501, leg tube lining connecting part 502, first limiting opening 503, first fastener 600, and ring beam baffle plate 700.

### DESCRIPTION OF THE EMBODIMENTS

In the descriptions of the present invention, it should be understood that an orientation or a position relationship indicated by the terms “one end”, “the other end”, “outer side”, “upper”, “inner side”, “horizontal”, “coaxial”, “center”, “end”, “length”, “outer end” and the like is based on an orientation or a position relationship shown in the accompanying drawings, and is merely intended for ease of describing the present invention and simplifying description, but does not indicate or imply that a described apparatus or element needs to have a specific orientation or be constructed and operated in a specific orientation. Therefore, such terms shall not be understood as a limitation on the present invention.

The present invention is further described with reference to accompanying drawings.

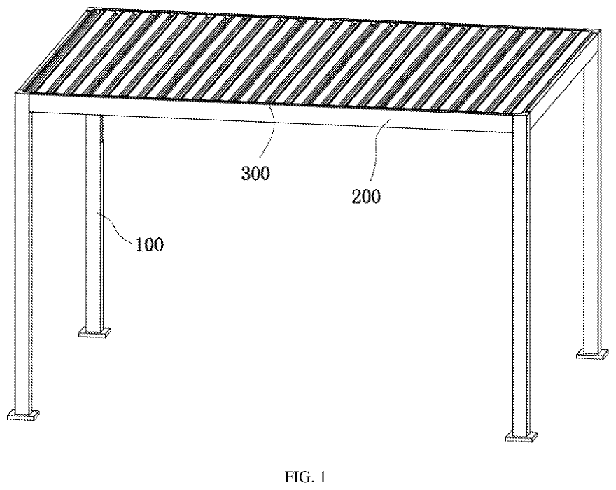

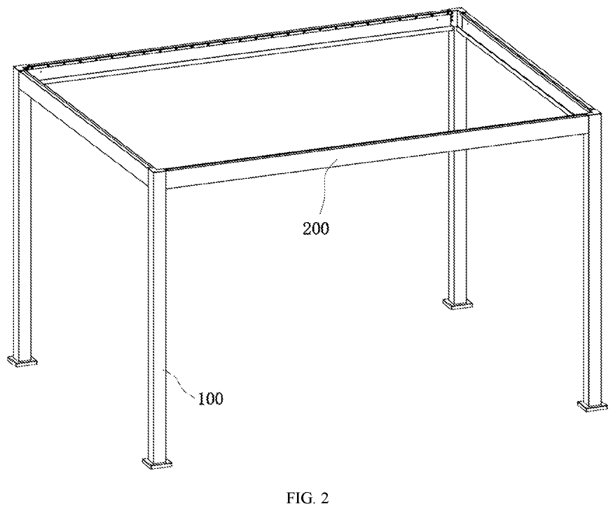

Refer to FIG. 1 to FIG. 16. A quickly installed, expandable, and modularly designed louver awning is provided, including several leg tubes 100, a ring beam frame disposed on upper ends of the leg tubes 100, and a louver system 300 disposed on the ring beam frame. The ring beam frame includes several ring beams 200 installed on the leg tubes 100. The ring beams are slidably installed on the leg tubes 100. Ring beam linings 400 are firmly disposed in ends of the ring beams 200. The ring beam linings 400 are connected to the leg tubes 100 through first fasteners 600.

In an embodiment of the present invention, the ring beams 200 and the ring beam linings 400 are fastened by welding, or may be connected through interference fit or fasteners.

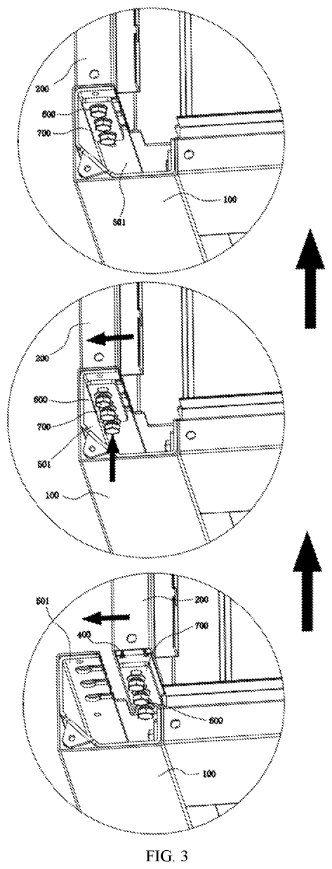

Still refer to FIG. 3. In an embodiment of the present invention, a leg tube lining 500 is fastened to an upper end of the leg tube 100, and the ring beam lining 400 and the leg tube lining 500 are connected through the first fastener 600.

The leg tube 100 and the leg tube lining 500 are fastened through a fastener, or may be connected through interference fit or by welding.

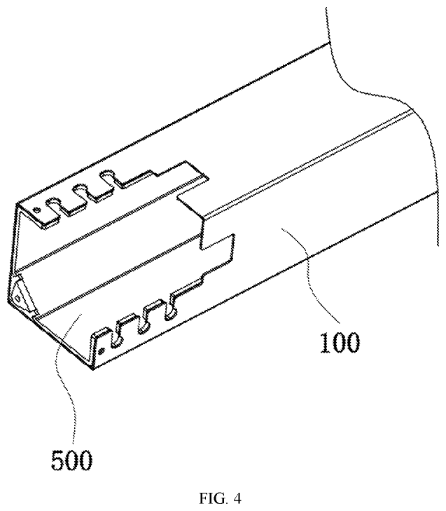

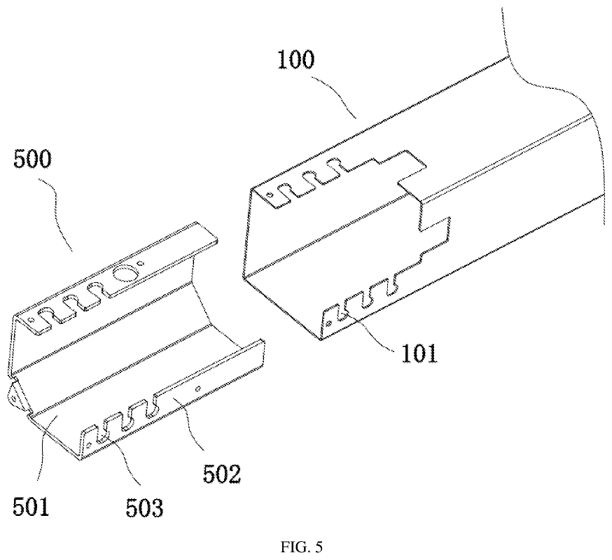

Still refer to FIG. 4 and FIG. 5. In an embodiment of the present invention, the leg tube lining 500 is an integrated structure, and includes a leg tube lining body 501 and two leg tube lining connecting parts 502 respectively disposed on two sides of the leg tube lining body 501. The leg tube lining body 501 is an L-shaped structure, and is configured to be embedded into a tube cavity of the leg tube 100. The leg tube lining connecting part 502 is turned inward, and several first limiting openings 503 are provided on the leg tube lining connecting part 502. The leg tubes 100 are provided with second limiting openings 101 at corresponding positions. These limiting openings are penetrated by the first fasteners 600 from a side surface, so that the ring beam 200 can be slidably installed on the leg tube 100, and the first fasteners 600 are bolts. With the design of the L-shaped structure, the ring beams 400 connected on both sides of the leg tube lining 500 form an L-shape.

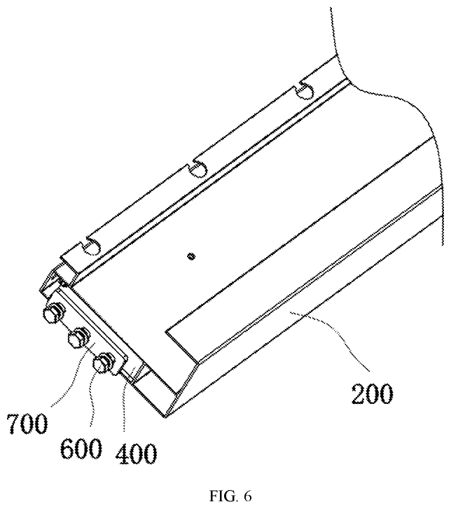

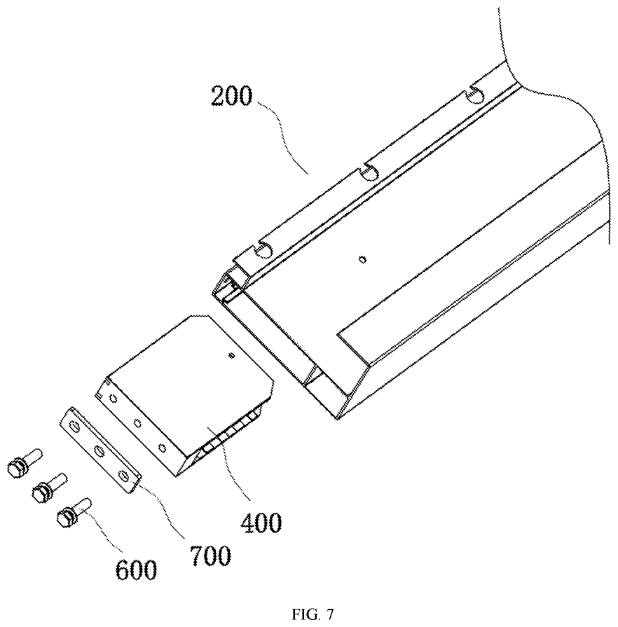

Still refer to FIG. 3, FIG. 6, and FIG. 7. The ring beam lining 400 is connected to the ring beam baffle plate 700 through the first fastener 600, and the ring beam baffle plate 700 is suspended and extends outside the ring beam 200 through the first fastener 600. The ring beam baffle plate 700 extends inside the leg tube lining 500. The ring beam lining 400 and the ring beam baffle plate 700 sandwich a shell wall of the leg tube 100. The first fastener 600 is hidden in the leg tube 100 and the ring beam 200 and connects the ring beam lining 400, the ring beam baffle plate 700, and the shell wall of the leg tube 100. The ring beam lining 400 is provided with a screw hole used to connect the first fastener 600, and the ring beam baffle plate 700 is provided with a through hole that the first fastener 600 penetrates.

Still refer to FIG. 3. When the leg tube 100 and the ring beam 200 are installed, first, the leg tube lining 500 is installed into an end of the leg tube 100, and the ring beam lining 400 is installed into an end of the ring beam 200. Then, the ring beam baffle plate 700 is installed on the ring beam lining 400 through multiple first fasteners 600. The first fastener 600 is connected to the ring beam lining 400 through a screw. The first fastener 600 is not fully tightened. The ring beam baffle plate 700 is inserted into the first fastener 600, and specific movement space is provided. Next, the first fastener 600 is inserted into the limiting opening from a side surface of the limiting opening, so that a head of the first fastener 600 is located in a tube cavity of the leg tube 100. A rod of the first fastener 600 is left in the ring beam lining 400, and the first fastener 600 is tightened after a position of the leg tube 100 is aligned with a position of the ring beam 200. The leg tube 100, the leg tube lining 500, the ring beam 200, the ring beam lining 400, and the ring beam baffle plate 700 are all tightly connected by using the first fasteners 600, and the first fasteners 600 are not exposed.

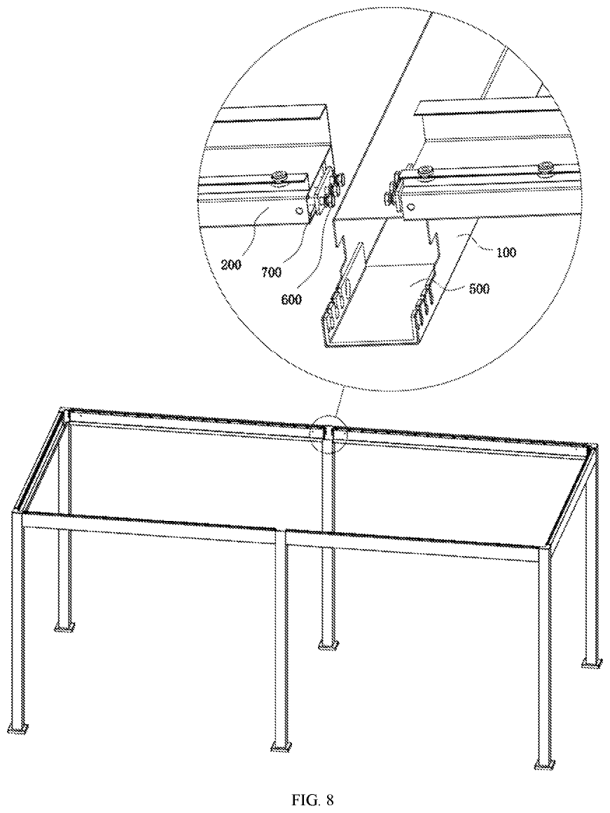

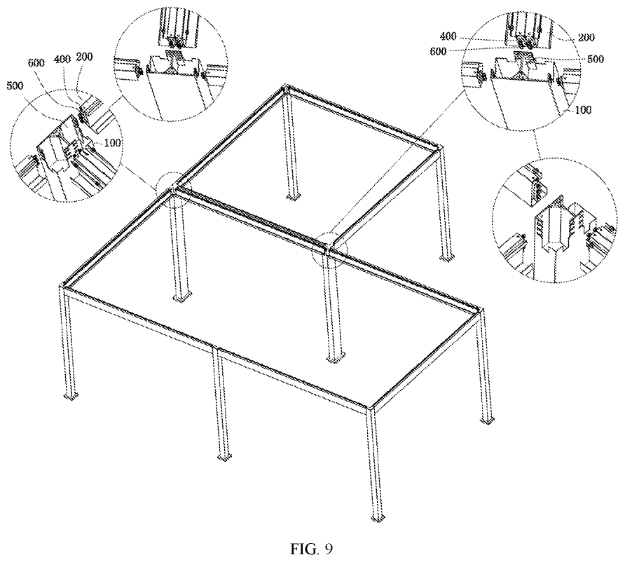

Still refer to FIG. 8 and FIG. 9. The leg tubes 100 of the present invention can be connected to ring beams 200 of another one or more louver awnings through the one or more leg tube linings 500, to implement modular expansion of the louver awning.

FIG. 8 is an example of splicing of two louver awnings. In the figure, two louver awnings share two leg tubes 100. One leg tube lining 500 is fastened to upper ends of the two leg tubes 100 separately. One leg tube 100 is connected to two ring beams 200 through one leg tube lining 500.

It should be noted that FIG. 8 also shows another embodiment of the leg tube lining 500. In this embodiment, a leg tube lining body 501 is a U-shaped structure, so that ring beams 200 connected to both sides of the leg tube lining 500 may be connected into a straight line.

FIG. 9 is an example of splicing of three louver awnings. In the figure, two adjacent louver awnings share two leg tubes 100. At a splicing part of the three louver awnings, the three louver awnings share one leg tube 100. It may be learned from the figure that, at some nodes, one leg tube 100 needs to be connected to three ring beams 200. In this case, two leg tube linings 500 are disposed relative to each other side by side on an upper end of one leg tube 100. Two leg tube lines 500 form an inverted ‘T’ shape, so that leg tube lining connecting parts 502 are generated in three directions, to meet assembly needs for connecting one leg tube 100 to three ring beams 200.

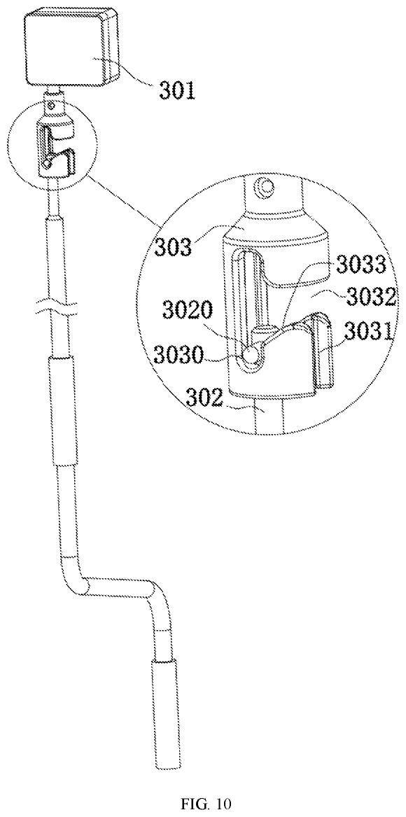

Still refer to FIG. 10 to FIG. 12. A louver system 300 includes a louver apparatus disposed on an upper end of the ring beam frame, a worm gear mechanism 301 configured to drive the louver apparatus to fold and unfold, and a rocking rod 302 configured to drive the worm gear mechanism 301 to work. An upper end of the rocking rod 302 is provided with a limiting part 3020, an input end of the worm gear mechanism 301 cooperates with and is connected to a hanging piece 303. The hanging piece 303 is provided with a limiting groove 3030, a bottom opening 3031, and a side opening 3032. The limiting groove 3030 communicates with the bottom opening 3031, and the limiting groove 3030 communicates with the side opening 3032. The limiting groove 3030 is configured to limit and cooperate with the limiting part 3020. The bottom opening 3031 is used for the limiting part 3020 to extend into the limiting groove 3030 from a bottom of the hanging piece 303. The side opening 3032 is used for the limiting part 3020 to extend from a side surface of the hanging piece 303 into the limiting groove 3030.

It can be understood that in the foregoing technical solution, according to the present invention, two angles including the bottom and the side surface are provided for the rocking rod to cooperate with the hanging piece 303, so that connection of the rocking rod is easier to align, more flexible, and easier to implement.

Still refer to FIG. 10. In an embodiment of the present invention, the bottom opening 3031 and the side opening 3032 are located on one side of the limiting groove 3030, and the bottom opening 3031 is located on a lower end of the side opening 3032. Both the limiting groove 3030 and the side opening 3032 are horizontally penetrating structures. The bottom opening 3031 communicates with the lower end of the side opening 3032 and a front side of the limiting groove 3030, the lower end and the front side penetrate to the outside, an upper end penetrates to the side opening 3032, and a rear side penetrates to the limiting groove 3030.

Further, refer to FIG. 10. In an embodiment of the present invention, a guide surface 3033 for guiding the limiting part 3020 into the limiting groove 3030 is provided on a lower inner wall of the side opening 3032.

It can be understood in the foregoing technical solution, with the design of the guide surface 3033, the limiting part 3020 is more easily embedded into the limiting groove 3030.

Still further, in an embodiment of the present invention, the limiting part 3020 includes two limiting pins respectively disposed on a left side and a right side of the rocking rod 302. A shape and size of the limiting pins match the limiting groove 3030, and an outer diameter of the limiting pins are smaller than a vertical width of the side opening 3032 and less than a horizontal width of the bottom opening 3031, so that it can be ensured that the limiting pins can penetrate the side opening 3032 and the bottom opening 3031.

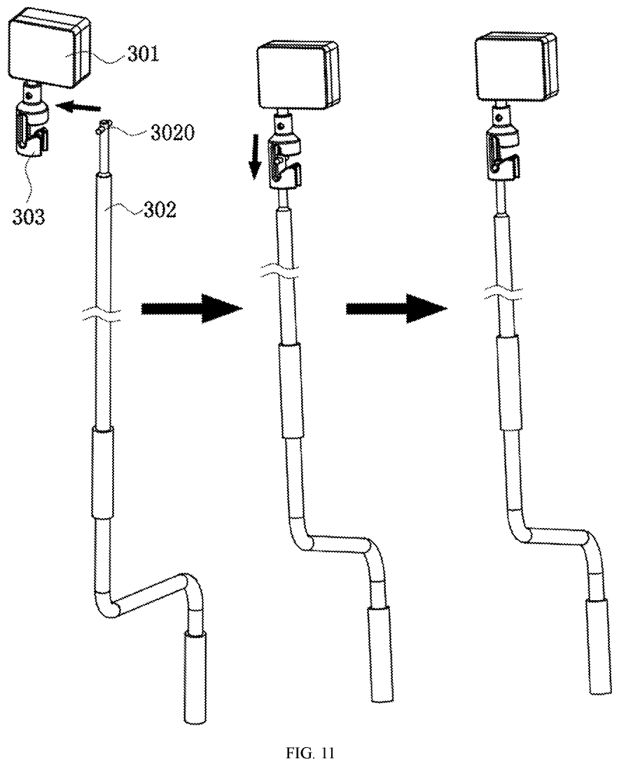

FIG. 11 shows an installation manner for the present invention at a side surface. An operation process is as follows: the rocking rod 302 is rotated to an angle and a position at which the limiting part 3020 is aligned with the side opening 3032, then the limiting part 3020 is inserted into the side opening 3032 from a side surface, and finally the limiting part 3020 is embedded into the limiting groove 3030, to implement hanging of the rocking rod 302.

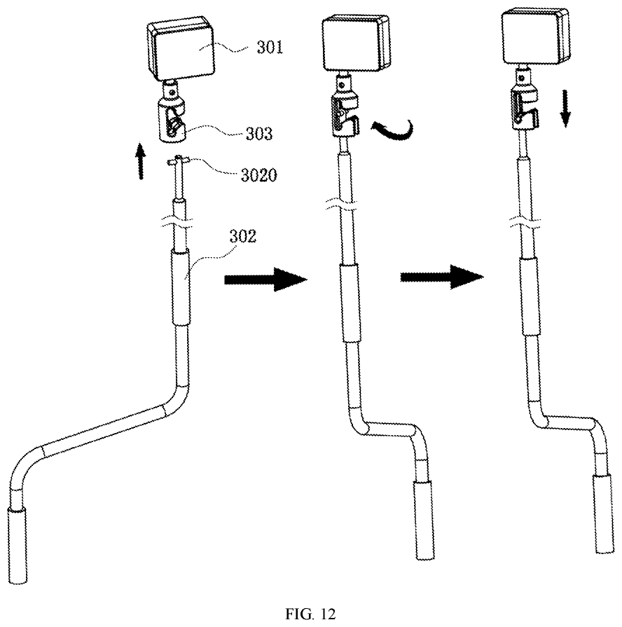

FIG. 12 shows an installation manner for the present invention at a bottom. An operation process is as follows: the rocking rod 302 is rotated to an angle and a position at which the limiting part 3020 is aligned with the bottom opening 3031, then the limiting part 3020 is inserted upward into the bottom opening 3031, the rocking rod 302 is rotated by 90°, so that the limiting part 3020 exactly faces the limiting groove 3030, and finally the limiting part 3020 is embedded into the limiting groove 3030, to implement hanging of the rocking rod 302.

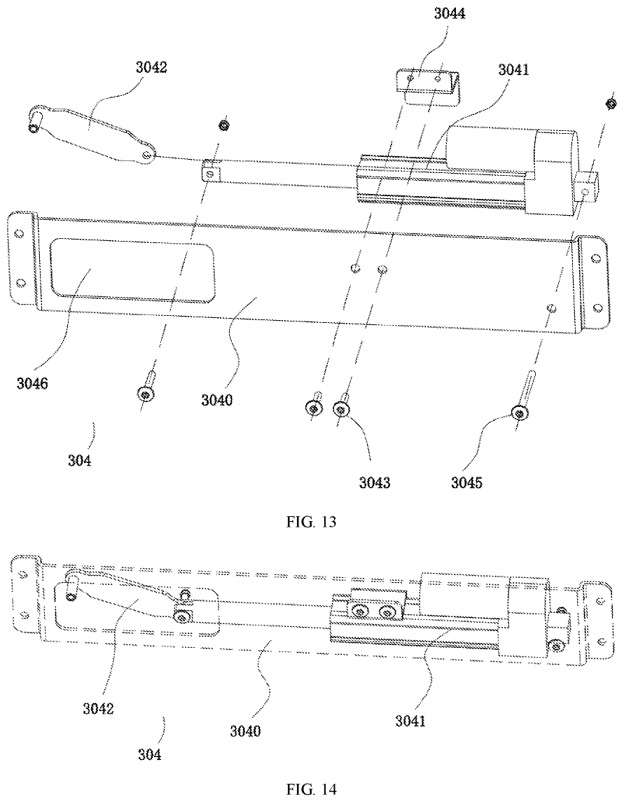

Still refer to FIG. 13 to FIG. 16. The ring beam 200 is provided with a ring beam slot 201, and the louver system 300 further includes an electric driving module 304 configured to drive a louver apparatus to fold and unfold, that is, the louver system 300 of the present invention is provided with two driving manners, namely, manual driving and electric driving. The electric driving module 304 includes a cover plate 3040 and an electric driving mechanism disposed on the cover plate 3040. The cover plate 3040 is detachably connected to the ring beam 200 through a bolt, and covers the ring beam slot 201 provided on the ring beam 200, and the electric driving mechanism is installed in the ring beam 200 through the ring beam slot 201.

It can be understood that in the foregoing technical solution, according to the present invention, the cover plate 3040 is used as a carrier of the electric driving mechanism, and is configured to install the electric driving mechanism, and the electric driving mechanism is hidden inside the ring beam 200, to improve aesthetic appearance and protect the electric driving mechanism, and the cover plate 3040 can strengthen a structural strength of the ring beam 200. In addition, only the cover plate 3040 is to be disassembled and assembled, so that operation and replacement are easy to implement.

Still refer to FIG. 13 and FIG. 14. In an embodiment of the present invention, the electric driving mechanism includes a push rod 3041 and a push rod connecting piece 3042 rotatably connected to the push rod 3041, and the push rod 3041 is an electric push rod.

In another embodiment, the push rod 3041 may alternatively be a pneumatic push rod or hydraulic push rod.

Still refer to FIG. 13 and FIG. 14. A rear end of the push rod 3041 is connected to the cover plate 3040 through a third fastener 3045, the cover plate 3040 is connected to a hoop member 3044 through a second fastener 3043, and the hoop member 3044 holds a body of the push rod 3041 tightly on the cover plate 3040.

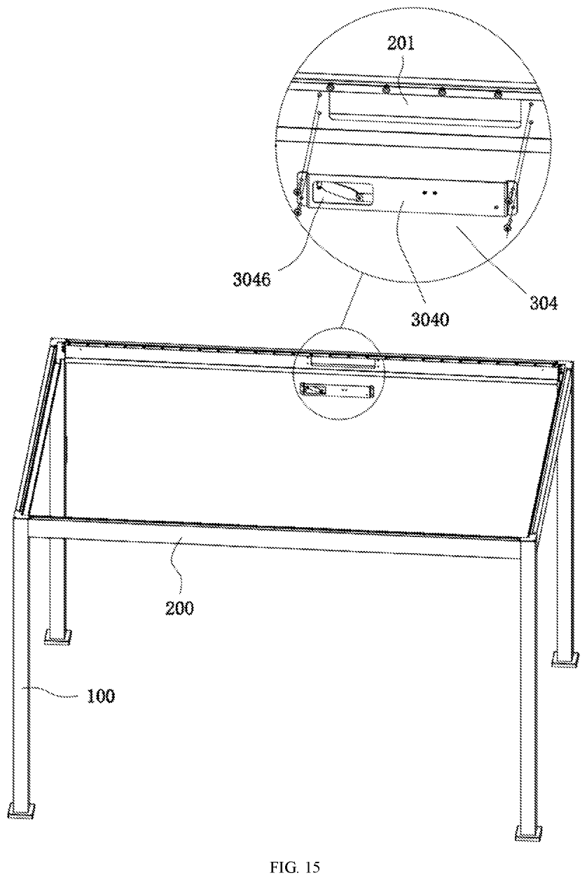

As shown in FIG. 15, the electric driving module 304 can be installed on an inner side of the ring beam 200, that is, the cover plate 3040 is installed on the inner side of the ring beam 200. The inner side is a side that is of the ring beam 200 and that faces a center of the louver awning, and the cover plate 3040 is provided with a movable opening 3046 for connecting the electric driving mechanism to the louver apparatus.

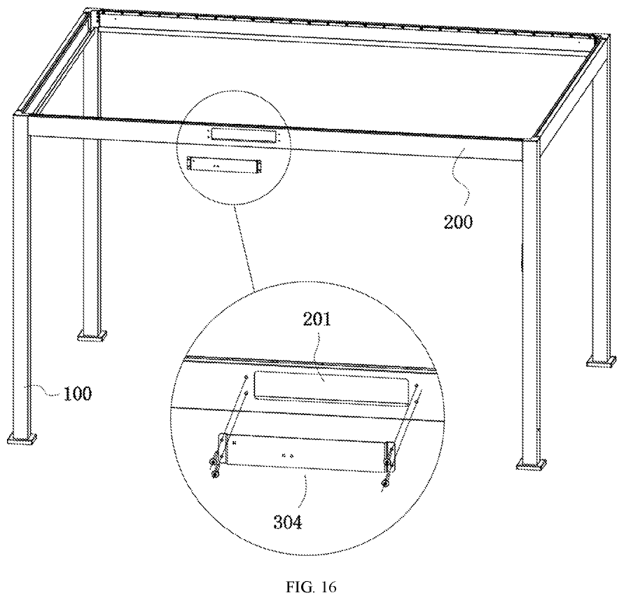

As shown in FIG. 16, the electric driving module 304 can be installed on an outer side of the ring beam 200, that is, the cover plate 3040 is installed on the outer side of the ring beam 200. The outer side is a side that is of the ring beam 200 and that is away from a center of the louver awning. In this case, the cover plate 3040 is sealed except a necessary installation hole, so that the electric driving mechanism is not exposed.

When the electric driving module 304 is installed, first, the electric driving mechanism is installed on the cover plate 3040 to form a module, and then the module is installed on the ring beam 200 through the cover plate 3040.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of embodiments of the present invention.

What is claimed is:

1. A quickly installed, expandable, and modularly designed louver awning, comprising:
several leg tubes;
a ring beam frame disposed on upper ends of the leg tubes; and
a louver system disposed on the ring beam frame,
wherein the ring beam frame comprises several ring beams slidably installed on the leg tubes, ring beam linings are firmly disposed in ends of the ring beams, and the ring beam linings are connected to the leg tubes through first fasteners.

2. The quickly installed, expandable, and modularly designed louver awning according to claim 1, wherein the ring beam lining is connected to a ring beam baffle plate through the first fastener, the ring beam baffle plate is suspended and extends inside the leg tube through the first fastener, the ring beam lining and the ring beam baffle plate sandwich a shell wall of the leg tube, the first fastener is installed in the leg tube and the ring beam and connects the ring beam lining, the ring beam baffle plate, and the shell wall of the leg tube.

3. The quickly installed, expandable, and modularly designed louver awning according to claim 1, wherein a leg tube lining is fastened in the upper end of the leg tube, and the ring beam lining and the leg tube lining are connected through the first fastener.

4. The quickly installed, expandable, and modularly designed louver awning according to claim 3, wherein the leg tube lining comprises a leg tube lining body and two leg tube lining connecting parts respectively disposed on two sides of the leg tube lining body, the leg tube lining body is configured to be embedded into a tube cavity of the leg tube, and the leg tube lining connecting parts are configured to be connected to the ring beam lining; and the leg tube lining body is an L-shaped structure or a U-shaped structure.

5. The quickly installed, expandable, and modularly designed louver awning according to claim 1, wherein the leg tubes are capable of being connected to ring beams of the other one or more louver awnings, to implement splicing or expansion between different louver awnings.

6. The quickly installed, expandable, and modularly designed louver awning according to claim 1, wherein the louver system comprises a louver apparatus disposed on an upper end of the ring beam frame, a worm gear mechanism configured to drive the louver apparatus to fold and unfold, and a rocking rod configured to drive the worm gear mechanism to work, an upper end of the rocking rod is provided with a limiting part, an input end of the worm gear mechanism cooperates with and is connected to a hanging piece, the hanging piece is provided with a limiting groove, a bottom opening, and a side opening, the limiting groove communicates with the bottom opening, the limiting groove communicates with the side opening, the limiting groove is configured to limit and cooperate with the limiting part, the bottom opening is used for the limiting part to extend into the limiting groove from a bottom of the hanging piece, and the side opening is used for the limiting part to extend from a side surface of the hanging piece into the limiting groove.

7. The quickly installed, expandable, and modularly designed louver awning according to claim 6, wherein the limiting groove and the side opening are horizontally penetrating structures, the bottom opening communicates with a lower end of the side opening and a front side of the limiting groove, the lower end and the front side penetrate to the outside, and an upper end penetrates to the side opening, and a rear side penetrates to the limiting groove.

8. The quickly installed, expandable, and modularly designed louver awning according to claim 6, wherein the limiting part comprises two limiting pins respectively disposed on a left side and a right side of the rocking rod.

9. The quickly installed, expandable, and modularly designed louver awning according to claim 1, wherein the ring beam is provided with a ring beam slot, the louver system comprises a louver apparatus disposed at an upper end of the ring beam frame and an electric driving module configured to drive the louver apparatus to fold and unfold, the electric driving module comprises a cover plate and an electric driving mechanism disposed on the cover plate, the cover plate is detachably connected to the ring beam, and covers the ring beam slot, and the electric driving mechanism is installed in the ring beam through the ring beam slot.

10. The quickly installed, expandable, and modularly designed louver awning according to claim 9, wherein the electric driving mechanism comprises a push rod and a push rod connecting piece rotatably connected to the push rod, the push rod is an automatically telescopic push rod, a rear end of the push rod is connected to the cover plate through a third fastener, the cover plate is connected to a hoop member through a second fastener, and the hoop member holds a body of the push rod tightly on the cover plate.
